(19) United States
(12) Patent Application Publication
(10) Pub. No.: US 2025/0362908 A1
(43) Pub. Date: Nov. 27, 2025

(54) CONTROL UNITS FOR HETEROGENEOUS COMPUTE PROCESSORS

(71) Applicant: Raminda U. Madurawe, Sunnyvale, CA (US)

(72) Inventor: Raminda U. Madurawe, Sunnyvale, CA (US)

(21) Appl. No.: 18/671,820

(22) Filed: May 22, 2024

(51) Int. Cl. G06F 9/22; G06F 9/28; G06F 9/38

(52) U.S. Cl. CPC G06F 9/223; G06F 9/28; G06F 9/3802

(57) ABSTRACT

A control unit to execute a micro instruction and an accelerator instruction in a processor, comprising: a means to navigate a micro instruction to a selectable plurality of pre-defined hardware units and select a pre-defined hardware unit to execute the micro instruction; and a means to navigate an accelerator instruction to a programmable logic hardware block programmed as an accelerator function and execute the accelerator instruction; wherein, the micro instruction data and accelerator instruction data reside in a common coherent cache memory structure. A control unit to facilitate a function instruction execution of a processor, further comprising a slave control unit to receive a command from the control unit via a plurality of control and status registers to execute a function programmed in a programmable logic block.

This application claims priority from Provisional Application Ser. No. 63/468,059 entitled “Macro-Processor Architectures”, filed on 22-May-2023 and Provisional Application Ser. No. 63/468,061 entitled “Content-Compute Processors and Architectures”, filed on 22-May-2023, all of which have as inventor Mr. Raminda U. Madurawe and the contents of which are incorporated-by-reference.

This application is related to application Ser. No. 18/656,824 entitled “Macroprocessor Architectures for Pipelined Flexible-Function Computing”, application Ser. No. 18/656,836 entitled “Content Compute Processors and Architectures” and application Ser. No. 18/656,851 entitled “Interconnect Structures for Configurable CPU Pipelines”, filed on 7-May-2024 and list as inventor Mr. Raminda U. Madurawe, the contents of which are incorporated-by-reference.

### BACKGROUND

### 1. Field of the Invention

The present invention relates to integrated circuits, and further relates to central processor units (CPU), field programable gate arrays (FPGA) and application specific integrated circuits (ASIC). CPUs includes microprocessors, microcontrollers and other instruction-based processors. FPGAs include other types of programmable logic devices (PLDs). ASIC includes Gate-Arrays and other forms of transistor-based accelerator circuits (such as neuron processors, language processors, in-memory compute units, and others). Integrated circuits comprise hardware architectures (HWA) that allow user-defined software code to execute in electronic circuits fabricated in semiconductor devices. Instruction set architecture (ISA) offers a set of instructions that can be compiled to an ISA compatible pre-defined HWA. Specifically, the invention relates to ISA-based microprocessor architectures that comprise a plurality of disparate HWAs. The invention includes control units that facilitates instructions and data flow among heterogeneous compute units within disparate HWAs inside CPU-Pipelines. Programmable heterogeneous computing allows application software content to execute in pre-configured hardware units, without the need to compile software into machine-instructions. A microprocessor comprising CPU-pipelined heterogeneous compute units is hereafter defined as a macroprocessor. This invention relates to control units that facilitate high-level programming language execution in hardware as compiled instructions: micro-instructions, macro-instructions, function-instructions, accelerator-instructions, static-instructions and dynamic-instructions.

### 2. Prior Art

A microprocessor, also known as a CPU, is a widely used first embodiment of a programmable device in the Integrated Circuits (IC) industry. The programming is done by executing ISA-instructions. It comprises a plurality of hardware structures (arranged in the HWA) to process the pre-defined instruction-set (the ISA). The matched HWA-ISA duality allows a control-unit to select a plurality of dedicated hardware structures to execute all instructions using control-signals. Each activity takes one or more clock cycles. Compiled instructions reside in memory, in the form of data-strings, and when the instruction is loaded (or read) into an instruction-register (IR), an IR decoding circuit instructs the control unit to provide hardware functions needed to execute the instruction. Hardware functions are circuit blocks, hard wired during manufacturing to perform specific functions, have one or more inputs, and generate one or more outputs in response to the inputs. In a single instruction multiple data (SIMD) variant of the microprocessor HWA, one instruction may select a plurality of identical pre-defined hardware functions to process multiple data inputs simultaneously. Parallel processing improves compute performance. In both cases, the instructions & hardware blocks are pre-designed to allow control-signals to select the cyclically desired hardware structures. The control unit orchestrates the data flow without any data conflicts to ensure efficient and accurate instruction execution within the CPU pipeline stages. Control units generate control signals that select pre-defined hardware structures. CPUs receive instructions and data via a coherent cache memory hierarchy. All the instructions and data for a CPU eventually arrive at an L1-cache (an L1-D$ and an L1-I$). The control unit manages the data flow and execution post L1-cache.

Instruction processing systems require the ISA to be tightly coupled to the chip HWA. Compilers map high-level SW code to Assembly Language, and assemblers convert assembly language into HW execution instructions with some inbuilt indirection. Fixed length RISC instructions lend to easy instruction decode and fixed bus-width HWA. Variable length CISC instructions create complex decode & bus-width in HWA. Post-synthesis code compaction is used in CISC ISA to identify RISC operands, justifying the need for both to co-exist to reduce code density. This division is difficult due to the pre-defined HWA bus structure. Every API can benefit from unique HW-block custom instructions, but having a HW-block super-set for general-purpose computing is not economical.

Input/Output (IO) device pad limitation is a major draw-back for data-bandwidth in chip scaling today. With RISC or CISC instructions, limited chip IO's must support both instruction-data and compute-data. More instructions reduce compute data & compute throughput. GPU's share a single instruction on multiple data (SIMD) using “identical” function-unit copies to enhance compute-bandwidth. High throughput over the last decade is credited for higher GPU/CPU ratios in HWA. GPUs are power-hungry, with very limited use-options, and require a host-CPU for general-purpose computing. Industry trends show a real need to lower instruction over-head, customize functional-units, use multiple-instruction-multiple-data (MIMD), improve performance, and reduce power. Repetitive instructions clog-up the data bandwidth arteries.

Tightly-coupled embedded-accelerators and co-processors demonstrate the need for “very-complex” function instructions to improve domain-specific API performance at lower power. ISA-extensions are commonly used to add co-processors. Cloud systems offer loosely-coupled board-level CPU/FPGA, & CPU/GPU chips in network cards with PCIe and DDR bus interfaces. Single chip CPUs with embedded FPGA-cores attempt to boost performance, if the user can re-partition the program & create a new FPGA Verilog code. All of these heterogeneous compute techniques use control and status register (CSR) commands for data compute acceleration, in addition to needing a custom compiler to incorporate the accelerator. These solutions are poor at context-transfer and do not fully exploit the potential of compute acceleration. There is a real need for easy to use, inter-operable, flexible function heterogeneous accelerators inside CPUs to improve performance & reduce power.

A field programmable gate array (FPGA) is a widely used second embodiment of a general-purpose programmable device in the IC industry. A programmable tile in an FPGA is constructed as an array of programmable blocks, programmable segmented interconnects, memory, digital signal processing (DSP) blocks, programmable switch-blocks and programmable routing-blocks. In an FPGA, there is a plurality of such tiles replicated with IO and other circuitry required to build the FPGA chip. Users customize the FPGA using a bit-stream generated by a software development kits (SDK) based on a user software application. Instructions are hard-coded into the FPGA as hardware connections by the Bit-Stream. The Bit-Stream ensures data execution accuracy by construction.

Unlike CPUs, high level C++/Jave code cannot convert to executable instructions in FPGAs. FPGAs do not have an ISA, nor machine-instructions as seen in CPUs, nor control-units to navigate data flow for execution accuracy. A single application must be re-coded in Verilog or RTL, synthesized to a netlist, placed and routed inside FPGA HWA to meet timing. A bit-pattern, loaded once at boot-time, freezes the time-stamped application in the general-purpose FPGA. An ASIC-block can be viewed as a frozen bit-pattern FPGA. While instruction-data is eliminated by bit-pattern, unclogging the data artery, the FPGA cannot adapt to evolving software, nor execute multiple programs concurrently. Bit-configurable interconnects in FPGA HWAs are difficult to dynamically re-configure due to damaging driver contention power surges. FPGAs do not have a cache hierarchy. It uses direct memory access (DMA) techniques to fetch needed data from memory structures. FPGAs are ˜10× slower than CPUs in frequency, has a data-flow that is in-order. CPU concepts such as stack & heap used by SW-coders do not exist in FPGAs. Software coding, ISA & HWA differences prevent pipeline-coupling of CPU & FPGA heterogeneous compute units. If we overcome these barriers, code suited for CPU-instructions can use CPU-HW; and code suited for FPGA can use FPGA-HW having a Software-ASIC connectivity to the APIs. FPGA-CPU architectures need to evolve. Control units and coherent cache memory subsystems need to evolve to accommodate heterogeneous computing.

### SUMMARY

This invention is to construct various embodiments of controllers for macroprocessors, content-compute processors and heterogeneous compute processors to overcome limitations in von-Neumann and Harvard type CPU architectures to improve performance, power, compute area, instructions per cycle (IPC), cost, compute density, flexibility, solution life-time (SLT), time-to-solution (TTS), non-recurring engineering (NRE) costs & data throughput.

A macroprocessor comprises tightly coupled software and hardware architectures that has the capabilities and features of a microprocessor, graphics processor, gate array, field programmable gate array, and application specific integrated circuit. A macroprocessor comprises a microprocessor, which has an ISA & HWA similar to a custom processor, ARM processor, x86 processor, MIPS processor, and RISC processor. Macroprocessor ISA attempts to make no changes, or minimal change, to an existing microprocessor ISA. A macroprocessor is more than a co-processor that expands an ISA. The microprocessor may comprise one or more of: memory units, registers, ALUs, FPUs, AGUS, BRUS, shifters, comparators, multipliers, integer processing units, DSP's, Analog Circuits, clocks, PLLs and other circuits found in CPU circuits. A macroprocessor comprise a field programmable gate array (FPGA). The FPGA may comprise one or more of: memory units, registers, ALUs, FPUs, carry-logic units, shifters, configurable logic elements, configurable memory (CRAM), look-up table logic blocks (LUT), comparators, multipliers, DSPs, Analog Circuits, clocks, PLLs, control status registers (CSR), configurable segmented interconnects and other circuits found in FPGA devices. The FPGA may be configured as a hardware accelerator. A macroprocessor may comprise a programable application specific integrated circuit (ASIC). The ASIC may comprise specific custom functions that are specifically designed to do complex functions, including hard-IP, soft-IP & Programmable-IP that can be integrated into chip design, including accelerator circuits that enhance compute performance. Memory may comprise any volatile or non-volatile memory element, including SRAM, flash, EEPROM, MRAM, eFuse, laser-fuse, DRAM and state-transition memory. Memory includes cache. Macroprocessor software and hardware architectures facilitates application software to utilize heterogeneous hardware components independent of user familiarity in HWA. The control-unit facilitates mix mode instructions execution in the macroprocessor.

A macroprocessor comprises an instruction adaptable control-unit that facilitate application software execution as micro-operations and macro-operations in heterogeneous hardware. These may be instructions generated by static-compilers, dynamic-compilers, or software-specific accelerator instructions. The instruction adaptable control unit may further comprise an instruction adaptable register coupling structure. The instruction adaptable register coupling structure may further comprise an instruction adaptable multiplexer that selects one of a plurality of registers as inputs to couple to a desired destination register, the decision identified by software based on a micro-operation or macro-operation of an instruction.

A macroprocessor comprise heterogeneous hardware structures (FPGA, ASIC, CPU) available inside configurable CPU pipelines. A macroprocessor provides Multiple Instruction, Multiple Data (MIMD) computing inside the CPU pipeline to significantly increase the compute density and IPC reduce net compute power. Macroprocessors offer enhanced feature and capabilities over microprocessors. Said features include: hardware architecture, firmware, instructions, hardware resources & configurations. Said capabilities include: performance, power, price, quality and reliability, CPI & other metrics used in IC comparisons. A macroprocessor adheres to case of high-level software execution in heterogeneous hardware units. Control-units facilitate cyclical hardware orchestration in accordance with instruction requirements.

A macroprocessor is a function expandable processor unit that includes one or more CPUs tightly integrated (pipeline coupled) with one or more in-flight field programmable (FPGA) slices. The in-flight dynamically configurable field programmable gate array slice is defined hereafter as a Flexible Accelerator Unit (FAU). An FAU is user configurable, comprising CRAM memory, and can be viewed as a Software-ASIC by the SW-developers. A macroprocessor an FAU in addition to traditional microprocessor execution units BRU, AGU, FPU, and ALU in a CPU-pipeline. Therefore, it can execute instruction commands in CPU microprocessor execution units, and functional commands in the FAU using its coherent cache memory hierarchy. An FAU may include all or a portion of the components of an FPGA. An FAU may include other novel circuits that are not traditional in an FPGA, such as analog-circuits & clock divider circuits, branch units, and program counters, scratch-pad memory, L0-memory, memory-management units and CPU-interrupts. The CPU maybe RiscV, MIPS, ARM, x86, or any other custom processor, comprising a pre-defined Instruction Set Architecture (ISA). The FAU is either configured at Boot-time, or dynamically prior to an instruction execution to perform a complex function. An FAU may be reconfigured in one cycle. An FAU may be reconfigured in a plurality of cycles, extending to 1000's of cycles depending on a configurable bit content reconfigured. One or more FAUs may be combined to build large macro-functions. FAU may implement one function at all times. An FAU may implement an instruction defined function during execution time. The FAU function implementation capability makes the macroprocessor function expandable. The advantage of hybrid CPU-instructions and FAU-functions within the pipelined coupled interconnect fabric include: (i) off-loading and accelerating heavily used and/or high-compute content functions as FAU fixed functions under CPU supervision; (ii) Synthesizing and implementing complex instructions in dynamically configurable FAUs as functions to expand a pre-defined CPU ISA (as an example, a RISC ISA can be expanded with CISC instructions converted to FAU functions); (iii) Providing Multiple Instruction, Multiple Data (MIMD) execution unit that can significantly increase Instructions-Per-Cycle (IPC) metric; and (iv) Providing high IO bandwidth to compute data by removing Instruction-Data into FAU configuration bits. A macroprocessor may provide IPC of 100× or 1000× for compute intensive Big-Data and HPC applications. When the CPU is a RiscV microprocessor, the macroprocessor may process existing RISC ISA, pre-synthesized CISC instructions (converted to FAU function), and heavy-compute accelerator ASICs (placed in FAUs functions). A MIMD macroprocessor offers significant IO-bandwidth and compute throughput advantages, and exceed microprocessor data compute capabilities in Big-Data & HPC applications. A macroprocessor operates in a Load-Store computer architecture and adhere to well established ISA & SW Tools infrastructure. A macroprocessor provides content computing. Fabrication of a macroprocessor may include advanced semiconductor manufacturing processes, including 3D-packaging technology. A macroprocessor augments von-Neuman and Harvard architectural bottleneck of single-instruction execution by parallel processing capacity of FAU-accelerators in a pipeline. An FAU may comprise 1000's of instructions in a single execution command. An FAU may comprise 1000's of parallel compute units that gets executed in a single Accelerator Execution command. Control-units orchestrate accurate functioning of instructions and data flow during micro-operational stages in heterogeneous hardware structures.

This invention will be more fully understood in conjunction with the following detailed description taken together with the drawings.

### BRIEF DESCRIPTION OF THE DRAWINGS

FIG. 1A shows a prior art computer processor unit (CPU) architecture.

FIG. 1B shows a prior art level and pulse control signals generation by a control unit sequencer.

FIG. 1C shows a prior-art multiplexer coupling of two output ports to an input port.

FIG. 1D shows a prior-art tri-state buffer coupling of two output ports to an input port.

FIG. 2A shows a prior-art construction of a simple output enabled single bus CPU architecture.

FIG. 2B shows a truth table construction of control level/pulse signals to utilize shared hardware resources to execute ISA-instructions in a pre-defined hardware architecture (HWA).

FIG. 2C shows an exemplary CLS/CPS signal generation logic in accordance with FIG. 2B.

FIG. 2D shows a prior-art control unit that generate micro-operational control signals for a plurality of ISA-instructions during each instruction micro-operational stages.

FIG. 2E shows a prior-art control signal generation for hardware utilization in ISA-instruction set micro-operations.

FIG. 3A shows a novel master-slave control unit to couple data between multiple ports in a heterogeneous compute CPU architecture.

FIG. 3B shows a novel slave control unit comprising byte configurable segmented bus architecture.

FIG. 3C shows a novel control signal generation for macroprocessor heterogeneous hardware.

FIG. 4A shows a first embodiment of a CPU comprising a flexible accelerator unit (FAU).

FIG. 4B shows a sequencer with variable cycle counts for use with macroprocessors.

FIG. 5A shows a novel macroprocessor construction element comprising a pre-defined CPU hardware, and a user configurable Flexible Accelerator Unit (FAU).

FIG. 5B shows a novel macroprocessor construction block comprising a plurality of construction elements as in FIG. 5A.

FIG. 5C shows a novel macroprocessor construction tile comprising a plurality of construction blocks as in FIG. 5B.

FIG. 6 shows a novel macroprocessor comprising 7 stages in CPU-pipeline with heterogeneous compute hardware content.

### DETAILED DESCRIPTION

In the following detailed description of the invention, reference is made to the accompanying drawings which form a part hereof, and in which is shown, by way of illustration, specific embodiments in which the invention may be practiced. These embodiments are described in sufficient detail to enable those skilled in the art to practice the invention. Other embodiments may be utilized and structural, logical, and electrical changes may be made without departing from the scope of the present invention.

The terms microprocessor and computer processing unit (CPU) used in the following description include any structure that can receive instructions and data, execute an operation, generate a result, and store that result. The structure comprises electronic circuits in an integrated circuit (IC) device. The structure is understood to include memory, control-units, decode circuitry, memory-tags, storage buffers, memory management units, cache structures, registers and other electronic circuits that are used to construct CPUs. The term pipeline is used to refer to the various structures in all of the stages required to process an instruction; from the time it is fetched from a memory location (such as instruction-cache) to the time it is retired after completing the instruction after writing results back into memory (data cache) if needed. It is understood that a plurality of instructions may be fetched in a super-scalar CPU, and a pipeline may have parallel branches to simultaneously execute multiple instructions. A pipeline may have in-order and out-of-order instruction execution capabilities, and for the later, additional structures required to ensure data integrity. The term thread is used to refer to a plurality of compiled instructions in a work-load that is generated from a user created software program during compile-time that comprise data dependency and an instruction-order that ensures execution accuracy. A compiled instruction is a hardware micro instruction that is executed in one or more cycles in pre-defined hardware structures.

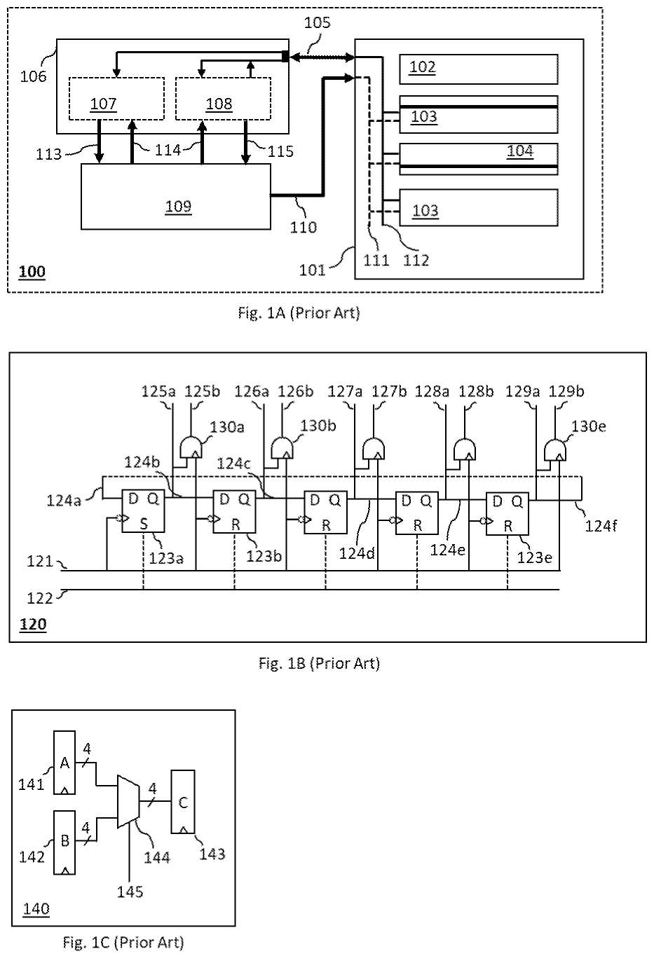

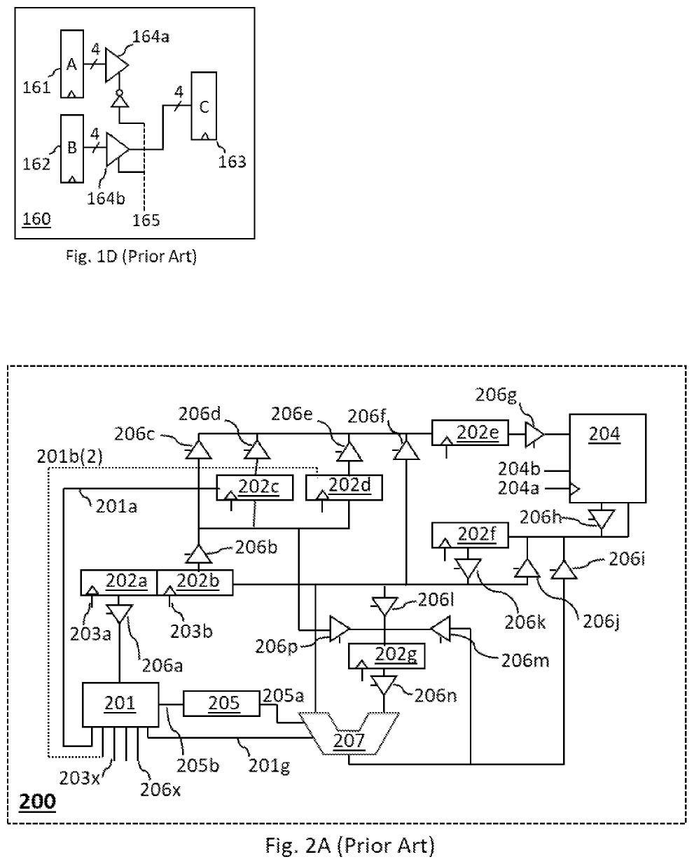

Ref-1, Ref-2 & Ref-3 provide an overview of computer architectures given in a series of lectures by David Murray, in Oxford University. All microprocessors follow Von Neumann data-path control-path architecture, or a modified Harvard architecture that split data-path into separate instruction-path and data-path. An exemplary prior art microprocessor 100 is shown in FIG. 1A. Microprocessor data is classified into two groups: (i) instruction data, telling the computer what to do and (ii) compute data, the information it needs to process at each instruction. An external memory unit 101, such as a Solid-State Drive (SSD), stores all the data. In memory 101, computer boot code may be stored in a region 102, compute data may be stored in a plurality of regions 103, and program instruction data may be stored in a region 104. Memory unit 101 has inbuilt control bus 111 to select a memory address, an inbuilt data bus 112 to retrieve/supply data during read/write from/to the memory address. Inbuilt logic in 101 (not shown) complete read/write memory functions based on control signal 111 information. In Von Neumann & Harvard architectures, CPU 100 comprises a data unit 106 and a control unit 109. Memory 101 couples to data unit 106 via bus 105, and to control unit 109 via bus 110. Data unit 106 may further comprise an instruction-register (I-cache) unit 107, and a compute-data (D-cache) unit 108. In Harvard architectures, they use independent data buses. Control unit 109 generates all hardware signals (level signals, pulse signals, hard-ware control signals, data transfers, etc.) to ensure execution accuracy. Control unit 109 receives instructions from I-cache 107 via data path 113; and it generates control signals 114 to keep I-cache & D-cache synchronized using data flags on 115. It also ensures continuity of instructions. Control unit 109 may respond to external controls (not shown, such as those generated by operating system or a thermal management system).

A significant breakthrough in Harvard-like architecture is that control section 107/109 is separated from data section 108/109. Hardware pre-defined micro-instructions dictate the required control signals for every operational clock cycle to operate hardware. Changing control signals 114 manage data movement from a memory read through execution units back into a memory storage. This is the basis for all CPUs that are in existence over the last 60-years. The downside is, since micro-instructions change every clock-cycle, control signals must also change every clock cycle to accommodate the cyclical instruction execution. Moving the same instruction multiple times leads to performance & throughput penalty with wasted power. It is desirable to improve performance and power in CPUs by augmenting Harvard architectures.

The control unit of a CPU issues hardware control signals to execute instructions accurately. There are two types of control signals: (i) control level signals (CLS), and (ii) control pulse signals (CPS). CLS selects connections between registers, and setup the execution mode of instructions. CLS set up data paths. CPS are gated clock signals that activate pulse signals to capture valid data into registers. CPS trigger data capture. Accurate combinations of CLS & CPS ensure cyclical operability and data connectivity in instruction execution. During each cycle, a unique CLS & CPS signal combination will ensure accuracy of all instructions within that cycle by eliminating contention in interconnects. A prior art sequencer 120 of a control unit to generate CLS & CLP signals for five consecutive cycles is illustrated in FIG. 1B. Sequencer 120 is comprised of 5 D-type flip-flops (DFF) 123a-123b . . . 123e coupled serially. DFF outputs are 124a, 124b, 124c, 124d, 124e, 124f=124a. Each DFF has an input (124a for 123a) which is the output of previous DFF, and an output (124b for 123a) which is the input to next DFF. Output 124f of last DFF 123e is fed to input 124a of first DFF 123a. Clock signal 121 is coupled to all DFFs 123a-123e. Set/Reset signal 122 initializes DFF states. When 122 is asserted, DFF 123a is set with Q=1 output state, while DFFs 123b-123c are reset with Q=0 output states. Output 125a-126a-127a-128a-129a are level signals CLS. Clock gated AND gates 130a-130b- . . . 130e use CPS signal and clock signal 121 as inputs to provide 125b-126b-127b-128b-129b pulse signals CPS respectively. In sequencer 120, CPS signals are shown as negative-clock triggered pulses. At every clock pulse, the active CLS=1 signal will propagate forward by 1-stage from 125a→126a→●●→129a, thereby ensuring cyclical accuracy in execution. All level signals must be logically enabled by CLSs, and all registers must be logically enabled by CPSs for every cycle. This is a pre-defined hardware architecture (HWA). CLS/CPS signals select pre-designed hardware structures during instruction execution. Every instruction in the ISA has a predefined plurality of control signal CLS/CPS sequence that are pre-defined throughout the instruction passage in pipeline stages from an initial load stage to a final store stage. Assemblers and compilers do not need specific hardware architecture (HWA) knowledge, they need to only compile micro-instructions that befits an application software program. Control units ensure data execution accuracy, avoid conflicts, and manage data dependencies.

An advantage of sequencer 120 is that every ISA-instruction can be broken down into hardware micro-operations, each micro-operation designed for a one or more known number of cycle execution. Logical function execution defined by an ISA-instruction is achieved by unique CLS/CPS signals pairs. The downside to sequencer 120 is, every micro-operation must be pre-defined. It must have a known number of clock cycles; all hardware structures must have a known delay quantized into pre-determined clock-cycles. That mandates hardware structures to be designed by CPU-manufacturers hard-wired and fixed during fabrication. It mandates user application software to be compiled into pre-determined hardware micro-instructions. That leads to performance and power penalties. Users do not get what they code—instead, the code is converted to a sequence of steps that can be delivered by the HWA. Sequencer 120 cannot handle variable or unknown hardware delays that were not planned during construction. It cannot handle software content in an application program, unless it is compiled to micro-instructions that select one of control-unit pre-defined set of control-sequences. It may be desirable to provide flexibility to a user to define their own hardware function that can be used for better efficiency, better performance, and lower power in CPU's. It is desirable to have flexibility in control-units.

In the event where a plurality of registers can be the source to a destination register, one or more additional selection control signals and a multiplexer is required. A first prior art embodiment 140 for register-register coupling is shown in FIG. 1C. In 140, a multiplexer 144 having select control signal 145 couple cither register 141 or register 142 to register 143, but never both to prevent contention and circuit damage. All registers have a common clock signal CPS (not shown) to latch data. In FIG. IC the registers 141-143 may have a plurality of DFFs in parallel (a Byte). The plurality, four, eight, or more, registers may form a Register-Port in 140. The terms register and register-port are used inter-changeably in this document. Destination register 143 may comprise one of latches and DFFs. A bus comprising a plurality of wires may couple one register-port to another register-port. Select control CLS signal 145 is generated by the control unit. A second prior art embodiment 160 for register-register coupling is shown in FIG. ID, wherein tri-statable drivers 164a & 164b having select control CLS signal 165 couple either register 161 or register 162 to register 163, but never both to prevent contention and circuit damage. One of the two drivers 164a or 164b is always disabled (or tri-stated). All registers have a common clock signal CPS (not shown) to latch data. In FIG. 1D the registers may have one or more DFFs. Select control signal (CLS signal) 165 is generated by the control unit. When an output driver is tri-stated, it will not couple the driver input signal to driver output signal. An output enable signal may be required to make a driver input couple to its output. By having a tri-statable driver in each of a plurality of register-ports, a desired register-port within the plurality of register-ports can be selectively coupled to another register-port by controlling output enables.

In FIG. 1C & ID, a single value (or bit) control signal is adequate to couple one of 2 input register ports A and B to one register port C. Register port 143 may only comprise latches. In Risc-V ISA, there are 32 general purpose registers GPR (register=register port). CPU hardware functions, such as ALUs and FPUs have two input banks. Data-latches in each of the two input-banks can receive data from any one of those GPR registers. For a 32-bit ISA, each register (or register port) has 32 DFFs, hence the data bus is 32 b wide. Two data buses feed into functional unit inputs from GPRs. The coupling may be fixed; meaning only one physical GPR register can couple to one hardware-unit (HWU) input. Or it may be MUX'd, meaning one of two or more GPRs may be selectively coupled to an HWU input. If 1ll 32 GPRs were to MUX into an input, control signal 145 & 165 in FIG. 1C & ID respectively needs to be 5-bits, and the MUX 144 needs to be 32:1. There are two such MUXs for the two input-banks. For super scalar processors, there are multiple HWUs in a pipeline, and using 32:1 MUXs incurs timing penalties, and area penalty that is too severe. In super scalars, the GPR registers are dedicated to HWU input ports to avoid this complexity. A renaming stage between logical and physical register addresses is inserted to account for the dedicated physical GPR assigned for use with a specific HWU input.

Had we used 32:1 MUXs, we need decode logic that would generate 5:32 MUX'd signals (5 control signals, 2⁵=32 MUX select signals). Five-bit values in control signal 145 will select one of the 32 GPRs to couple to an input port of ALU or FPU every clock cycle. By changing control signal 145 every clock cycle, we can selectively change the GPR register that feed into a hardware function unit. This is a big advantage for microprocessors: changing GPR data register that couples (feeds data) into an input port of a functional unit every clock cycle. The disadvantage with this is that the control unit must continuously provide control signal 145 every clock cycle, and the data-path is firmly attached to moving data from D-cache through random GPR registers to functional unit input port. If we consider 1024 continuous operations (say ADD operations), the 2*1024 operands will move from D-cache into random GPR's, then into the same ALU input port of functional-unit in 1024 steps. Clocking control signals through multiple micro-operations adds unnecessary cyclical operations in fetch, re-name, re-order buffers; consume more power, at a loss of performance for 1024 consecutive additions. What is desired is a method to simplify data-flow, reduce micro-operations, improve performance and save power for sequential repetitive operations.

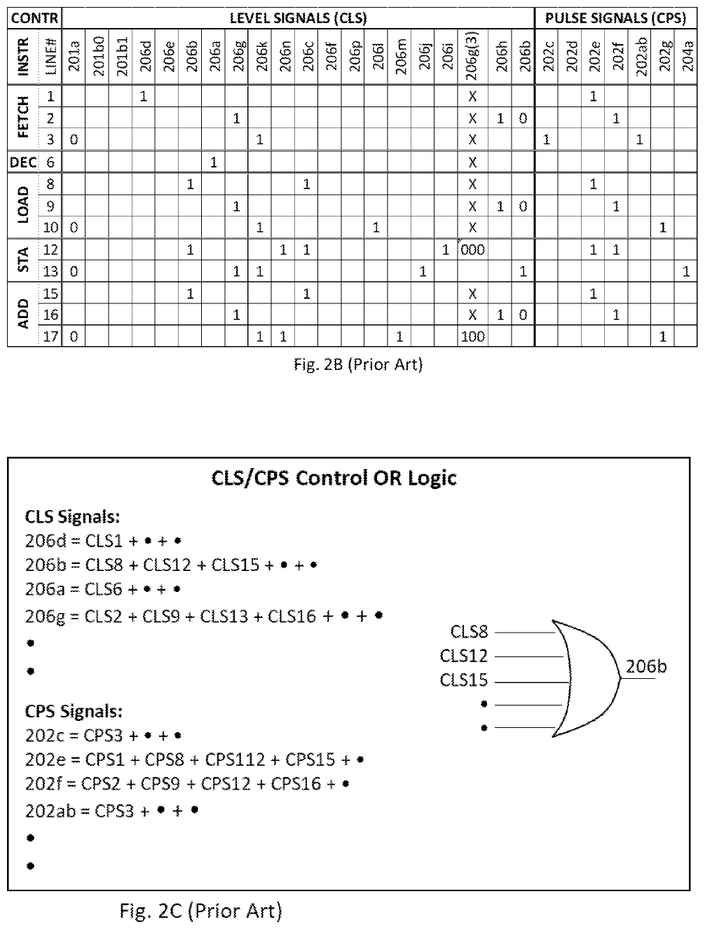

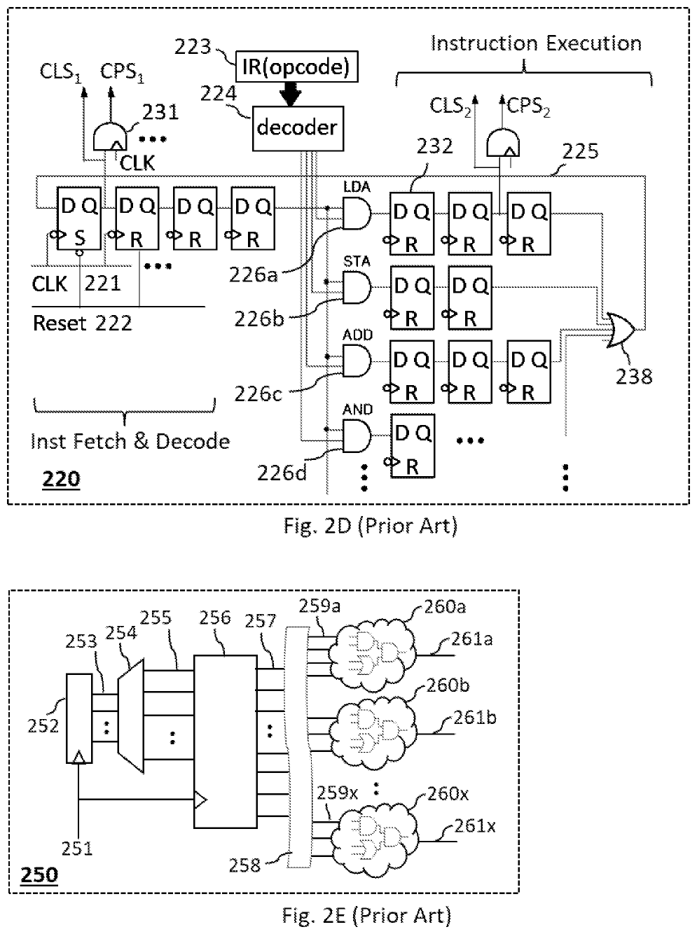

A prior art microprocessor 200 having tri-statable driver register-ports (as in FIG. 1D) is shown in FIG. 2A. The microprocessor 200 comprises a control unit 201, memory unit 204, a plurality of registers (each a register-port) 202, a hardware-unit such as an arithmetic-logic unit (ALU) 207, and a plurality of tri-statable drivers 206. For diagram clarity, logic associated with the registers and gated clock-signals are not shown: they are simply lumped into a single label. For this simplified microprocessor illustration, the registers are: 202a=instruction OPCODE register, 202b=instruction ADDRESS register, 202c =program counter register, 202d=stack pointer register, 202e=memory address register, 202f =memory data register, and 202g=ALU accumulator register. Each of the register-ports 202x receives a gated clock CPS control signal 203x generated by control unit 201. Program counter 202c receives a load (=0) or increment (=1) CLS signal 201a on CPS 203c (not shown) signal. Stack pointer 202c receives a two-bit CLS signals 201_b0/b1 (1x=load from bus, 01=increment, 00=decrement) on CPS 203d (not shown) signal. Memory unit 204 receives memory read (=0)/write (=1) CLS 204b and CPS 204a. ALU 207 provides status tags via 205a to status register 205, the output of which is coupled to control unit 201 to determine in-use or availability of ALU. Each of the tri-statable drivers 206x comprises a CLS output enable signal, also designated by same label 206x. When enabled, the input of driver is coupled to its output, when dis-abled, the driver is tri-stated. The control-unit 201 generates the CLS and CPS at every clock cycle as described in FIG. 1B. These signals are associated with instructions defined by Instruction Set Architecture (ISA) of the microprocessor, and the no-conflict signals are compiled into a look-up-table upon compilation of the micro-instructions.

An exemplary truth-table (TT) for five instructions is shown in FIG. 2B for microprocessor 200. In HWA of 200, a FETCH instruction may require three cycles (1, 2, 3): cycle 1 to set the address in register 202e, cycle 2 to read the addressed instruction data in 204 into register 202f, and cycle 3 to transfer the instruction-data to instruction-register 202a/b. Use of 3-cycles is for illustrative purposes when interconnects are shared by a plurality of register-ports, and it is understood that dedicated interconnects can allow a FETCH operation to occur in 1-cycle at the expense of added area/cost. The instruction is split into OPCODE bits 202a and ADDRESS bits 202b, both written by a common CPS 203a/b. FIG. 2B shows the CLS and CPS that will ensure cyclical accuracy for the FETCH operation. Line numbers 1, 2, 3 must occur sequentially, and a sequencer as in FIG. 1B will ensure that operation. The driver-enable signals 206 will ensure Register-Register data transfer as needed to move data from Memory 204 to Instruction-Register 202b. DECODE instruction occurs in 1-cycle when OPCODE is in 202a, is coupled to decode-logic in control-unit 201 by output-enable CLS 206a activation. The OPCODE will generate the required ALU control function selection signal 201g[3] to select the appropriate ALU function. In this example, ALU is assumed to have a 3-bit selection. We assume 000=no-operation, 001=NOT, 010=OR, 011=AND & 100=ADD operations. Similarly LOAD instruction also comprise 3-cycles in this exemplary HWA, where data-address from 202e is used to read memory data 204 at that address, and transfer that to ALU accumulator register 202g. The fourth STORE instruction writes data in data-register 202f into memory unit 204 at the address assigned by 202e. Memory WRITE control signal 206b must be asserted. The fifth ADD instruction retrieves data specified in address register 202e from memory 204 to data register 202f, and adds it to Accumulator 202g data, writing the result back into Accumulator 202g (via enabled 206m driver). What is illustrated in FIG. 2A is a bus structure in Microprocessor 200, wherein data transfer between registers (also called register ports) occurs without contention by CLS & CPS control signals generated in control unit 201 at every cycle of operation. It is easy to visualize how the number of individual wires needed for control signals can grow, thereby having to restrict the number of control choices available in any given HWA. This is a major down side for control-unit based CPU architectures. It would be beneficial if we could provide more connectivity choices.

In the truth-table in FIG. 2B, the HWA defines all horizontal CLS & CPS signals needed for each of the micro-operation program cycles. The ISA in conjunction with HWA define instructions and line#'s of the table. A generic high-level program (such as C++, JAVA, Python) does not depend on ISA or the HWA. Assemblers and compilers convert high-level program to micro-operations (or micro-code), thereby linking the high-level PGM to a specific ISA and to a specific HWA as shown in FIG. 2B. The hardware structures are pre-defined so that CLS/CPS signals can select the needed hardware structures. An ISA compatible HWA does not change the vertical instruction categories in FIG. 2B (such as fetch, decode, load, store, add, etc.), but it can change the line#'s associated with each micro-operation. Adding or subtracting line#'s (micro-ops) in each instruction does not change the ISA, but reflects a change in HWA. Opcode in the instruction register uniquely identify every instruction supported by ISA. For 1024 instructions in an ISA, there needs to be 1024 row-blocks in FIG. 2B. Each ISA-instruction may have 1 or more HW-instructions. For example, LOAD instruction has 3 HW-instructions in lines 8-10. Row header CLS and CPS signals are generated by a logic OR function of the vertical columns in FIG. 2B. Logic construction is shown in FIG. 2C, and CLS signal 206b is illustrated.

A prior art state machine construction of a control unit 220 is shown in FIG. 2D. Clock signal is 221, and reset signal is 222. The one hot state machine as in FIG. 1B is for illustrative purposes only, and the controller may be constructed as a PROM or a PLA, or discrete gates. In 220, Opcode 223 may comprise n-bits, allowing maximum N=2ⁿ unique operational modes (or ISA instructions). For 8-bits, this is 256 modes; and for 3-bits, it's 8 modes. Opcode is decoded in an n:N decoder 224 that generates a “1” signal for the decoded operation. Illustration shows four instructions, LOAD, STORE, ADD, & AND. Of the N-outputs of decoder 224, only one output will carry a 1-signal (selected); the rest have 0-signals (deselected). Controller 220 has a dedicated horizontal branch of a plurality of DFFs 232 coupled back-to-back (as in FIG. 1B) for each decoded function. Each branch has two halves: the right side showing the micro-operations, and the left side showing the fetch and decode operation needed to bring an instruction and decode it. Both require CLS/CPS signal generations 231. Not all of these are shown for diagram clarity. During each micro-op cycle, a set of CLS & CPS are generated. Those are used to facilitate accurate data movement and hardware structure utilization and to avoid resource conflicts, as shown in truth table FIG. 2B. CLS/CPS signals are predefined for every ISA-instruction in the HWA. Every instruction begins with an instruction fetch, left side, and it is common to all. In 220, fetch is shown to have 4 micro-ops. This number of micro-ops in each instruction will match with the truth table in FIG. 2B. For continuous operations, the controller 220 initiates micro-ops by a walking “1” from left to right. First an instruction is fetched to IR register 223. Four micro-ops (fetch=3, decode=1) facilitate that instruction movement in 200 of FIG. 2A from memory 204 to decode stage. By then the walking one in fetch stage (left side) has reached the last micro-op DFF Q-output, which is a common input to all instruction logic gates 226. Decoded output selects which branch (226a-226b-226c-226d) to as only one of 226 logic-gate outputs will be at “1” state. Once the instruction macro-ops are completed, OR-gate 238 will cycle the walking “1” back to first micro-op in fetch stage to start the next instruction fetch. This continuous operation will continue until there are no more instructions to fetch, or there is an interrupt.

In modern computers, there is a fetch buffer, and blocks of instructions are moved into the fetch buffer. A FIFO operation may load instructions continuously from the fetch buffer into the IR register. Also, FIG. 2A illustrates a common instruction and data bus computer. Separating the two improves parallel instruction fetch and data fetch. In instruction execution, the micro-ops contribute to high power consumption and poor performance on many work load types.

As an example, let us consider 1024 multiply-accumulate (MAC) math function. This is a very common vector operation in large language models (LLM) in AI. There is a repetitive 1024 times (load, multiply, move, load, add, store) that must sequentially occur. Let's consider the following number of cycles for each instruction: load=3, multiply=6, move=1, add=3, store=2. Then 1-MAC consumes 18 cycles, generating 18 pairs of CLS/CPS signals in the 6 micro-operations of the MAC sequence. This sequence is traversed 1024 times. That amounts to 18 k logic operations for the 1024 MACs. Clocking signals all the time repeatedly, even when a sequence of instructions does not change, consumes power. Sequencer power, logic power and clock power all add up. In general, the control unit 220 includes: functional unit controls; program counter controls; stack-pointer controls; interrupt controls; scratchpad controls; address controls; and other control features. It includes fetch-units and load/store units. While a customized programmable-ROM unit can also generate the 1-0 CLS/CPS signals, FSM control unit 220 cyclically CLS & CPS signal generation is easier to visualize.

Microprocessor control unit 250 in FIG. 2E shows an overview of the prior-art features described in FIGS. 2A-2C. An ISA-instruction OPCODE is latched into opcode register 252, duplicating the opcode bit-values. An n:N (inputs: outputs) decoder 254 converts the opcode to one of N ISA-supported instructions (N≤2ⁿ) by setting the appropriate output 255. Outputs 255 feed into a sequencer 256, such as in FIG. 2D, which has every ISA-instruction defined. An undefined ISA-instruction would not exist in sequencer, and it would interrupt or halt the operation. Sequencer 256 generate level (CLS) and pulse (CPS) signals 257 as described in FIG. 2D. Sequencer 256 and instruction registers receive a clock signal 251. Sequencer 256 may comprise a programmable-ROM. Sequencer output signals are used as defined by truth-table entries, such as FIG. 2B, to generate control signals 259(a-x) for every hardware resource under control unit management. A signal routing mesh 258 routs the plurality of signals 259 to logic units 260, such as FIG. 2C, that generate CLS/CPS signals 261. These CLS/CPS signals 261 define the header row control signals shown in FIG. 2B. For every single micro-operation of an instruction, it will generate the logic state defined by the truth-table in FIG. 2B. Control signals 261 manage data-movement, memory read/write, and functional-unit execution, etc. all mandated by ISA-instruction set and micro-operations in HWA. The symbols shown in logic block 260 represent the use of fixed logic gates, typically OR-gates, to generate CLS/CPS signals. Control unit 250 generates control signals 261 to select pre-defined hardware structures to execute instructions cyclically. Instructions move through a control path, and data move through a data path, the two decoupled in modern CPU architectures (FIG. 1A). The CLS/CPS control signals do not provide atomic actions (collective micro-operations all at once), do not offer gate definitions and gate level connectivity, and they do not construct hardware features. They simply select pre-defined hardware features to facilitate micro-operations in a cyclical sequential manner. Inability to create atomic actions, having to generate repeated cyclical micro-operational control signals 261, has significantly hampered CPU capability metrics over the past 60-years. Von-Neumann bottleneck refers to the instruction processing restriction in CPUs that limit state-of-the-art super scalar IPC to exceed ˜3. We need a novel CPU architecture that overcome von-Neumann & Harvard architectural limitations to improve power, performance, compute-density and data throughput. Simplifying ISA-instructions may restrict backward compatibility with existing software code. Increasing ISA (such as in co-processors) requires new compilers and user learning, making adoption difficult. New CPU architectures must use existing industry standards to leverage the vast design community knowledge and experience in using standard tools. Change must appear transparent to the user, such as using new drivers in hardware that appear transparent to users. Augmenting Harvard-like architectures must appear transparent to user. Enhancements to controller unit to achieve that must also appear transparent to user, further offering power, performance, throughput and efficiency advantages to users.

Although the illustrations of prior art are to provide a background to demonstrate some of the disadvantages, it is to be understood that the areas for improvements needed are not limited to these precise disadvantages shown. One skilled in the art may describe other embodiment and modifications in prior art that warrant improvements to process Big-Data, High-Performance-Computing & AI-computing more effectively, cheaper, faster, at lower power, cyclically, customizable, SW coder accessible, using existing SW tools, provide data & model parallelism, sequential, improve instruction efficiency & improve IPC.

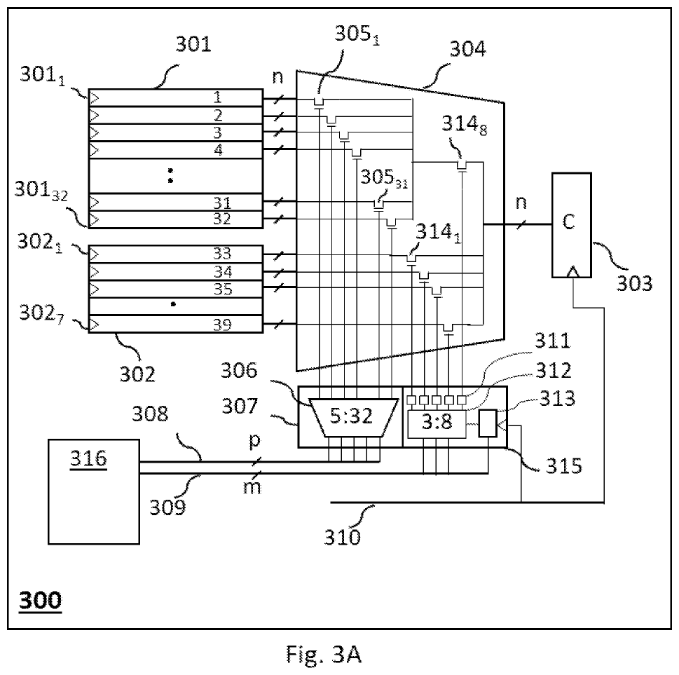

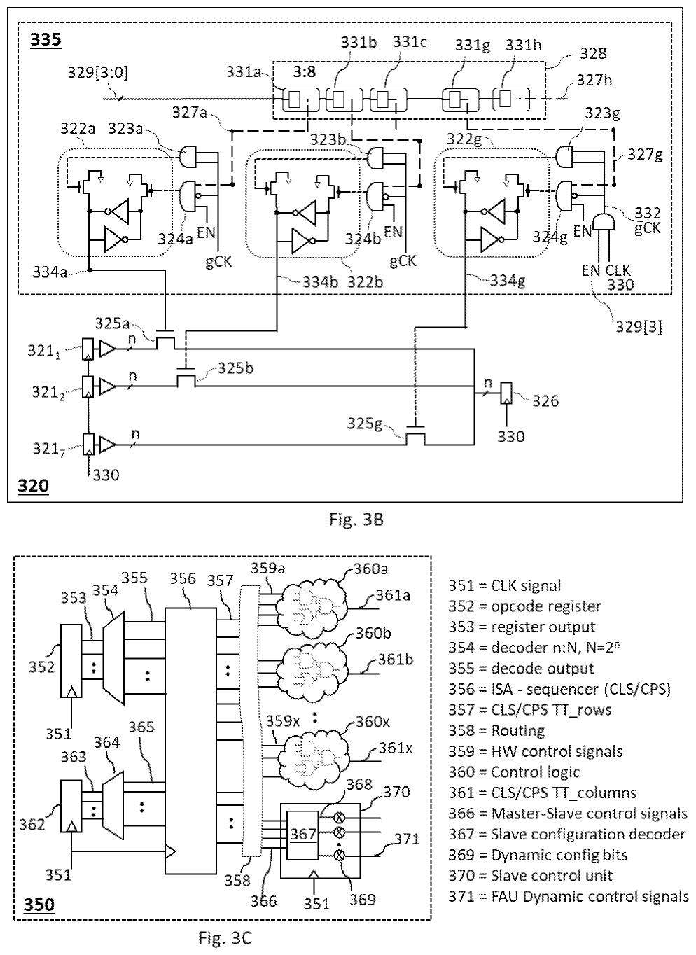

A first embodiment of an instruction adaptable register coupling structure 300 is shown in FIG. 3A. Compared to the prior-art register coupling structure 140 in FIG. IC, the structure 300 provides a first mechanisms to couple a first plurality of registers 301₁-301₃₂ (first register-bank) to register 303; and a second mechanism to couple a second plurality of registers 302₁-30₂₇ (second register-bank) to the register 303. In a preferred embodiment, register 303 comprises a plurality of input-latches as commonly found on inputs of hardware execution units. We used 32-registers in 301 register-bank to reflect 32 general purpose registers (GPR) common in a Risc-V ISA. It could be any number of registers (fewer or more) and not limited to 32. The first register-bank 301 may be used in micro-operations of a Macroprocessor with data changing every clock cycle. The second register-bank 302 may be used in macro-operations of a Macroprocessor with data changing every clock cycle. Register 303 may be used in micro-operations, or macro-operations, or used in execution unit input-latches for micro & macro-operations. The first mechanism has micro-operational multiplexing similar to Prior-Art 140 in FIG. 1C: multiplexing in 304 having switches 305₁-305₃₁ decoded by a 5:32 decoder-multiplexer 306 to select a desired switch to couple one of 301₁-301₃₂ to 303. We need 5-bits in bus 308 to decode 32 choices (p=5 for 32 GPR's in 301). It is understood that in some super scalar CPUs the GPRs 301 may be directly coupled to the inputs of hardware execution units (i.e. only 301₁ is coupled to 314g, and MUX 306 is not needed). When a plurality of GPRs 301 is coupled to 314g, this multiplexing in 306 may change dynamically every clock cycle to clock cycle, enabling any one of the GPR register 301 to couples to register 303 via selection gate 314g in each clock cycle. Since micro-ops are cyclical, we can use one of a plurality of registers 301 inputs to couple to 303 during a macro-operation. A register-configured single mux-switch 314₈ can be programmed to enable the first register-bank 301 to couple into register 303. This is new feature: when micro-ops are in use, switch 314₈ is used to select a GPR register 301 (either one GPR register directly coupled, or one of many GPR registers selected by MUX 306) to provide inputs to register 303. Switch 314₈ is enabled when GPR register 301 is coupled to register 303. Switch 314₈ is disabled when one of a plurality of registers 302 is coupled to register 303. A bit-state in a plurality of configurable storage bits 311 selects the coupling choice between first 301 and second 302 register banks, as well as which register in 302 bank is coupled to register 303. This selection need not be dynamically changed every clock cycle. Having a latch/register 311 holding a data state allows flexibility on using GPR registers 301 and expand registers 302. A latched data-state avoid toggling signals every cycle, leading to less power and less (signal coupling) noise. That decision may be driven by user-intent to use outputs of macro-ops, stored in register 302, as inputs to micro-ops execution unit having 303 as its input. Back-and-forth computing between CPU execution units and Function execution units improve pipelining and compute performance at reduced power. This configurability allows re-use of outputs of one execution unit as inputs to another execution unit to improve compute performance. A signal-generator unit 316 generates the 5-bit CLS signals in bus 308 similar to generating signals 261a-261x in prior-art 250 of FIG. 2D. In some super scalars, this may not be required as only one GPR register exist as input to 314g. The second mechanism in 300 is novel (to be discussed in 320 of FIG. 3B in detail), it carries an intent instruction to configure a dynamically configurable latch 311 (comprising a plurality of latch elements). In an example, there are 8-latches 311 for 7-registers in second plurality of registers 302, and bus 309 comprise 4-bits. These numbers are for illustrative purposes only, and may change. Together, 306 and 312 form a selection MUX 307 to couple one of 301 and 302 to 303. When bank 301 is coupled to 303 (i.e. 314₈ is enabled), all latches in bank 302 are set to decouple state (i.e. 314₁-314₇ are disabled). When bank 302 is coupled to 303, 314₈ is disabled, and one of the remaining 7-latches 314₁-314₇ determine which of the 302₁-302₇ is coupled to 303. Having latched controls eliminate the need for cyclical changes in control signals 309 in the second mechanism. The second mechanism further comprises: an m-bit control bus 309 (m=4 in afore discussed example), a 3:8 decoder-MUX 312 (m−1=3 decode bits, 1 enable bit), a plurality of latches 311 (2^{m-1}=8 latches), and a clock signal 315. The enable bit is used to reset/write data into latches 311. Latch values are clocked in by setting (m−1) latch decoder bit settings as control unit CLS signals, and the enable as a gated clock signal (320 of FIG. 3B).

What is shown in 300 of FIG. 3A is: a control unit 300 comprising a control-signal for a first register 301 to couple to a second register (or latch) 303 generated by a configurable data state of a storage element 311. The data state of the storage element 311 may be dynamically changed every cycle, or changed as needed by setting the desired decode signals and an enable signal (in combination called the control signals) in the bus 309.

Use of storage elements in control circuits is described in incorporated by reference Provisional Application Ser. No. 63/468,059 entitled “Macro-Processor Architectures”, which provides details of decoding and cyclical dynamic configuration. An embodiment of circuit blocks 311-313 in 300 of FIG. 3A, using configurable storage elements, is shown in 320 of FIG. 3B. In 320, control section is 335. In 320, bus 329[2:0] carry the 3-bits to configure eight 3:8 decoders 331a-331h in decoder circuit 328 (same as 312 in 300); and together with enable signal 329[3] represent the 4-bits in 309 (and 329) bus signals in 300 & 320 respectively. The 3-bits in 329[2:0] provides 8 independent states via 331a-331h to configure latches 322a-322h (latch 322h is not shown). Latches 322a-322g control coupling selection of registers 321₁-321₇, none or only one selected among the plurality of choices. Latch 322h (not shown) controls the register-bank 301 selection in 300 of FIG. 3A (314₈ select signal). The 8 decoders 331a-331h outputs the sequence of configuration signals 327a-327h needed from 3-bit 329[2:0], the 3:8 mapping function given by: (000, 00000001), (001, 00000010), (010, 00000100), (011, 00001000), . . . , (111, 10000000). Gated clock signal gCK 332 is generated by Enable EN 329[3] and clock CLK 330 by an AND logic function. When EN 329[3] is asserted, during +ve phase of CLK 330, all latches 322 enter reset state (i.e. all outputs 334a-334h set to zero, disabling all register coupling). At reset state, a latch stores a data-value “0”. When EN is asserted, during-ve phase of CLK 330, the one latch with decoder outputs 327a-327h that has “1” will be set to data state “1”, while the remaining latches will remain at data-state “0”. AND-gates 323a-323h ensure proper reset in all latches 322a-322h. Logic-gates 324a-324h ensures that one of the latches 322 will be set to a data-state “1” only if EN is asserted; while there is no data-disturb when EN is not asserted (i.e. EN=0). Switches 325a-325g facilitate one of the registers 321₁-321₇ coupling to register/latch 326. A switch 325h (not shown) facilitates register/latch 326 to couple a different group of registers, such as 301 in 300. The advantages of having a register/latch generated control signal are as follows. Once a latch is set, it can remain set until a change is desired. This facilitates batch-mode data processing. The selected gate signal 325 does not toggle. When data-flow to selected 321 register is pipelined and cyclically continuous, that data will flow into an input register/latch 321 of an execution-unit cyclically. It provides higher data and compute through-put. It requires less conflict management when latch 326 input port is computing macro-functions, i.e. logic unit using 326 inputs is pipelined and synchronous to received input-data.

Control unit described in 300 & 320 of FIG. 3A & 3B can be summarized by 350 in FIG. 3C. A comparison with prior-art control unit 250 shows the novel features of the invention. In 350, control signals for a macro-instruction 362 are assigned by the master control unit 350 to a slave control unit 370 to locally generate a plurality of dynamic control signals for a programmable execution unit (such as FIG. 3B). The clock signal is 351. In control unit 350, a first ISA instruction Opcode 352 acts on micro-instructions according to an ISA of a microprocessor. A second instruction Opcode 362 acts on a macro-instruction according to a user defined function that is programmed into a flexible accelerator execution unit (FAU). In a preferred embodiment, a single Opcode of a macro-instruction replace an equivalent 10's-100,000's of micro-instruction, thereby significantly reducing the instruction-data in the user program (better for lower power and higher compute bandwidth). A pre-fetch unit (not shown) may inspect the instruction and determine if it goes to an instruction-queue (not shown) that feeds 352, or an instruction-queue (not shown) that feeds 362. The top-half of 350 is similar to prior art 250 in FIG. 2D, so it will be described briefly. Register 352 outputs 353 match Opcode bit count, and is identical to 253. The n:N decoder 354 & decoded outputs 355 are identical to 254 and 255, supporting all ISA instructions. Sequencer 356 is modified from 256 to include hardware components for macro-instruction 362 execution. CLS/CPS signals 357 form the rows in truth-table FIG. 2B, signal routing block 358 channel those selected 359a . . . 359x etc. signals to OR-logic 360a-360b . . . 360x that generate CLS/CPS 361a-361b . . . 361x signals given in the columns of truth table FIG. 2B. Control signals 361a-361x match signals 261a-261x in 250 of FIG. 2D as required by ISA micro-instructions. Micro-instructions are executed in micro-operations (aka micro-ops). The bottom-half of control unit 350 (supporting register 362) is a new adaptation in control unit 350 to integrate macro-instruction execution. Macro-instructions are executed in macro-operations (aka macro-ops) in the FAU (not shown). FAU comprises programmable logic, configuration elements, and a programmable means to configure the configuration bits to program a user specified function. In the FAU, a portion of the configuration elements are configured by the plurality of dynamic control signals 371 generated by the slave control unit 367, based on the value of the dynamic configuration bits 369.

A macro-instruction may comprise 10's-100,000's of micro-instructions. A macro-instruction is executed as a macro-function, programmed in programmable logic as a hardware function. The hardware function may require a first plurality of configuration values to determine a static functionality, and a second plurality of configuration values to determine a dynamic functionality, together defining the complete hardware function. Hardware function receives control signals 371 to receive the dynamic configuration values. In a first embodiment, the dynamic configuration values may not be needed, the entire hardware function then determined by only the static functionality. In a second embodiment, a plurality of dynamic configuration value patterns (sets) determines a plurality of hardware functions, all of said plurality of hardware functions sharing the common static functionality. The programmable means comprises a configuration circuit and a bit-stream to program the programmable logic FAU (not shown) along the lines of FPGA techniques. In this novel implementation, configuration elements are classified into two types: static configuration elements, and dynamic configuration elements. The static configuration elements only change during a boot operation, static configuration values are programmed by the configuration circuit using an extracted bit-stream. The dynamic configuration values may change dynamically, but that dynamic change may or may not occur cyclically. The plurality of dynamic configuration values may be modified by a portion of a macro instruction. The macro instruction does not carry the complete functional description of a hardware function that is determined by both static and dynamic configuration elements. The Opcode is simpler, comprising of data register addresses and dynamic configurability assignments. This is a significant advantage in control-unit 350: register 362 is very shallow (i.e. few bits), outputs 363 very few (i.e. 1-8) and decoder 364 with outputs 365 is less complex (say 2-4 bits), and outputs 366 is a 2b-8b bus to slave-controller 370 to generate the local dynamic control signals 371 for the FAU. Master control unit 350 may use a modified sequencer 356 to generate control signals 366 to a slave control unit 370. This will be described later. In another embodiment, the slave-control unit command is taken over by a control-feature inside the FAU itself, which is an added value in this master-slave control unit arrangement. There may be shared bus resources used for data movement between micro-ops hardware and macro-ops hardware. CLS/CPS signal generation in truth-table in FIG. 2B needs to be augmented for macro-ops. This will be described later. In addition to micro-ops CLS/CPS signals 361a-361x, outputs 371 generate macro-ops CLS/CPL signals.

Outputs 361a-361x change cyclically as required by micro-ops to operate the hardware correctly. Macro-ops are geared towards high compute data, that may or may-not require dynamic control signals to change every cycle. Once a macro-op is selected, the same function may be continuously used to pump data in repeated execution mode. Dynamic configurability may occur cyclically, or at random, allowing FAU functionality to change cyclically or change only when needed. In a first embodiment, unit 367 receives a static code 366 to generate static signals 368 for a fixed set of dynamic configuration values in 369. In a second embodiment unit 367 receives cyclically changing codes 366 to generate dynamically changing control signals 368 that set configuration values in 369 dynamically. Slave control unit 367 appropriates required configuration conditions such that when enable is assessed, latches 369 first reset to a neutral state in a first clock polarity, and sets to a desired configuration pattern in a second clock polarity. Programmable logic FAU functionality is dynamically altered by this dynamic configurability, and the reset ensures no driver contentions within the FAU that may damage circuits. Once the configuration latches 369 have a valid data-state, by design there is no driver contention, and that data-state is retained until the next latch assignment is programmed. The control-unit 350 is able to generate static or dynamically changing control signals 366, to trigger slave control unit 367 to dynamically program a logic function in FAU utilizing slave control signals 371.

In summary, a control-unit 350 comprises a slave control unit 370, and a bit-code 366 to direct the slave control unit 370 to generate a plurality of dynamic control signals to alter the functionality of a plurality of programmable hardware functions coupled to the slave control unit. The slave control unit further comprises a plurality of latches, so that the control unit directive is stored in a static mode to execute a fixed hardware function, and or a dynamic mode to dynamically vary the hardware function. A macroprocessor comprises a master control unit that directs a slave control unit comprising configuration elements to generate a plurality of control signals to couple a plurality of user defined micro hardware functions to construct a macro hardware function.

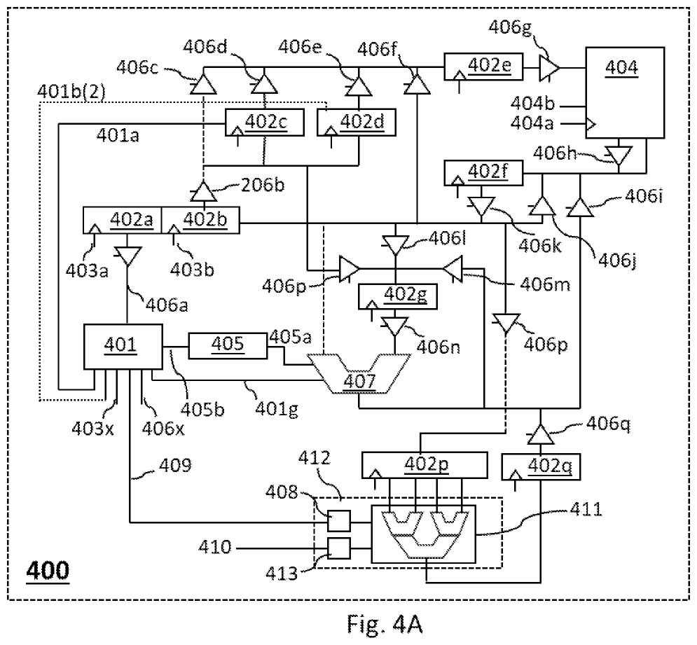

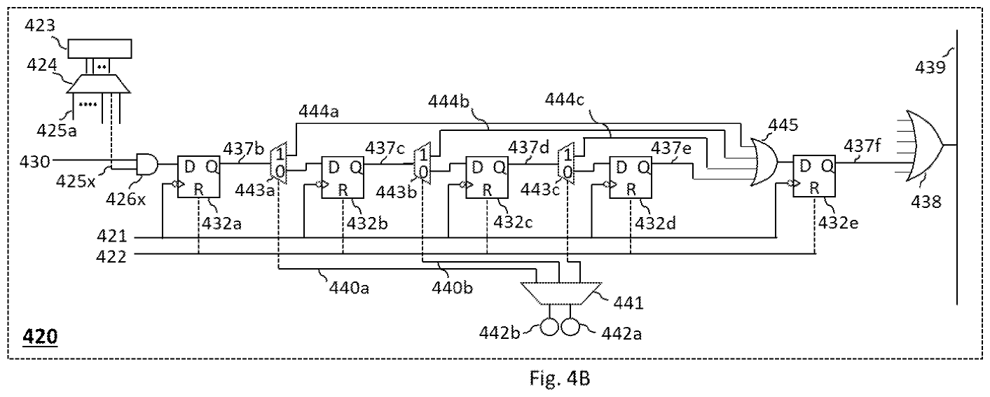

An embodiment of a macroprocessor 400 comprising flexible accelerator unit (FAU 412) is shown in FIG. 4A. A direct comparison with prior art 200 in FIG. 2A shows the integration of FAU 412 within an ISA-based CPU pipeline. FAU 412 content comprises a configuration circuit 413, slave control unit 408, and programmable FAU-logic block 411. The configuration circuit is enabled to receive an external configuration bit-stream 410 to configure a portion of the programmable FAU-logic block 412. This state is defined as static configuration, and the configuration elements are defined as static configuration elements. In a first embodiment, static configuration may program the entire programmable content of 411, and in a second embodiment it may program a portion of the programmable content in 411. The slave control unit 408 receives a control signal 409 from the master control unit 401. Slave control unit 408 may comprise a plurality of control and status registers (CSR). Master control unit 401 may transfer FAU 412 control to slave control unit 408 via the CSRs. CSRs may reside in either control units 401 or in 408. In another embodiment, the master-slave designation may be altered via CSR vales, where control unit 408 acts as the master, and control unit 401 acts as the slave. Control unit 408 comprises a plurality of storage elements, and is able to interpret the control data 409, and program the plurality of storage elements as described in FIG. 3B. These storage elements generate a plurality of dynamically alterable (via bit-code in master control signal 409) control signals. These control signals configure configuration elements within the FAU-logic 411, said configuration elements within 411 defined as dynamic configuration elements. In said second embodiment, the static and dynamic configuration elements together define the hardware function. Different dynamic configuration patterns define different hardware functions. Thus, the control unit 401 can dynamically assign a different hardware function by assigning a bit-code 409 directive to slave control unit 408. Register ports 402a-402g are analogous to 202a-203g in FIG. 2A. An OPCODE in 402a is interpreted as a micro-instruction, or a macro-instruction. A micro-instruction triggers a sequence of micro-ops to process the instructions, as shown by FIG. 2B & FIG. 2D. A macro-instruction comprises triggering a control input 409 to slave control unit 408, and assigning input/output ports to transmit data. In 400, the hardware-function has an input port 402p, which may comprise a much wider data width compared to ALU 407. The output port of FAU-logic 411 is 402q. Data inputs at 402p is computed and the result is latched at output 402q, the delay varying based on the complexity of the hardware function programmed into FAU-logic 411. In this simple illustration, tri-state buffers 406p and 406q allow data flow into FAU-logic 411. FIG. 4A is a simplified view of a macroprocessor to illustrate the inclusion of programmable execution unit 411 together with a pre-defined execution unit 407. In a preferred embodiment of the macroprocessor, the data path is designed to allow both ALU 407 and FAU-logic 411 to function simultaneously, in parallel. With a cache structure (not shown) this requires a dual data path. An ALU-path between data cache and ALU 407 registers, and an AFU-path between data cache and FAU 411 registers. Control unit 408 may comprise a load/store unit to access data in a data buffer for FAU 411. The data-width of the FAU data path may be substantially higher that the data path for CPU hardware. For a 32b RiscV architecture, the CPU data-path may be 32b, whereas the FAU data path may be 1024b or 4096b.

In summary, 400 in FIG. 4A shows a macroprocessor comprising a control unit 401 that engages a slave control unit 408, and a configuration circuit 413 to provide dynamic programmability via the slave control unit 408, and static programmability via configuration circuit 413 to program a user defined function in a programmable execution unit 411.

The user defined FAU hardware function may have a latency that varies with the complexity of the functions. As an example, in FIG. 2B, it was shown that Fetch has a latency of 4-cycles, while decode only has a latency of 1 cycle. These fixed latencies are built into the sequencer in FIG. 2D. Once the decoder decodes the OPCODE, the sequencer ensures micro-ops execution that meets the latency and the correct CLS/CPS at every cycle. In moder computers, this process is much simpler, preferably most ISA-instructions occur within 1-cycle. There are always exceptions. In an FPU, add may take 4-cycle, multiply may take 7-cycles, while a divide may take 23-cycles. Since these are pre-determined FIG. 2D can be constructed ahead of time. A sequencer with variable cycle counts for use with macroprocessors is shown in FIG. 4B. A comparison with prior-art 220 in FIG. 2D illustrates the new features. In 420, Opcode in instruction register 423 is decoded in 424 (the four micro-ops to do that are not shown in 420). The clock signal is 421, and reset signal is 422. Each decoded outputs 425 (425a, . . . , 425x, . . . ) represent an ISA-instruction, similar to decoded outputs 225 in FIG. 2D. Decoded output 425x represent an ISA-accelerator instruction that is used to identify a macro-operation for a macro-function programmed into an FAU. application Ser. No. 18/656,836 entitled “Content Compute Processors and Architectures” discloses software tools and tool flows that convert a pragma-wrapper identified user content in a high-level application software program to synthesized gate level netlist, and a physical implementation in an unprogrammed FAU fabric by generating a bit-stream to program the FAU. An orchestration layer termed syn-compiler inserts the macro-function instruction into compiled code. The syn-compiler has synthesis software to generate the gate level netlist, logic pack, place, route (PPR) and timing optimizer software (aka FPGA style software development kit SDK) to generate the bit-stream for physical implementation. During this SDK physical implementation, the latency of the user-content converted to a macro-function is determined. The latency is not known apriori as each user will need their own software content to become a custom-ASIC. In 420, the latency is programmed into a plurality of storage elements 442. As an illustration, only 2 bits 442a and 442b are shown. Two bits can program a variable latency of 2 to 5 clock-cycles. Three bits can program 2-9 cycles, and N bits can program 2−(2^{N}+1) cycles. An N:2^{N} decoder 441 generate a plurality of decoded signals 440 to control a variable delay DFF 432 chain. Letters adjacent to numbers are used to denote different stages. A “0” signal to MUX 443 will propagate a predecessor DFF 432 output 437 to the next DFF; a “1” signal in any one of 444 will forward the predecessor DFF 432 output 437 to the last DFF 432e via the OR-gate 445. This intermediate DFF by pass method provides the variable delay in the sequencer 420. In the shown illustration, bit codes (00, 01, 10, 11) will generate signals 440a-440d as follows: (100, 010, 001, 000). The bit codes will generate latency delays (2, 3, 4, 5) respectively. Maximum latency delays for (2, 3, 4, 5, 6) bits are (5, 9, 17, 33, 65) respectively. The Macro-instruction 425x is initiated by a logic-1 in input 430 using AND logic in 426x, which must account for instruction fetch and decode delays. In a preferred embodiment, the macro-instructions are fetched as a FIFO from a fetch-buffer. In such a case, there is no pre-delay in the fetch pipelines and instructions can proceed one after the other by coupling 437f to input 430. This can be a direct coupling, or a configurable MUX coupling. Final OR gate 438 & output 439 are analogous to 238 & 225 of FIG. 2D used in ISA instruction delays.

The sequencer for prior-art macro-operation is provided with CLS/CPS outputs (125-129 in FIG. 1B) as they control data flow and hardware structure usage in cyclical operations. This complexity is eliminated in macro-operations. The entire data flow and hardware utilization is determined during physical synthesis to be accurate by design. It simplifies the sequencer 420 to a simple cycles counter. In another embodiment, the cycle counter is provided as a FAU feed-back signal to the control-unit, so it can trigger the next macro-instruction execution upon a command. In another embodiment, the latency of the FAU is divided into a multiplicity of a smaller latency value. For example, a latency of 12 may be divided into 4 as 4×3-latency. Inside the FAU, registers are used in between 3 latency delays. In a sequential macro-operation, pipelined into 4 divisions, the macro-function can be operated 4 times faster to improve performance. In that scenario, the sequencer is set to latency=4, and not latency=12. In summary, 420 in FIG. 4b shows a sequencer in a control unit that can be set to a variable clock delay, wherein the variable clock delay is identified during a physical implementation of a user defined software content placement as a hardware image in the FAU. Lack of intermediate CLS/CPS signals allow control unit to simply assign addresses for inputs and outputs of FAU-execution unit. It facilitates very high bandwidth data executions in the FAU, including a plurality of SIMD & MIMD functions as a single macro-function.

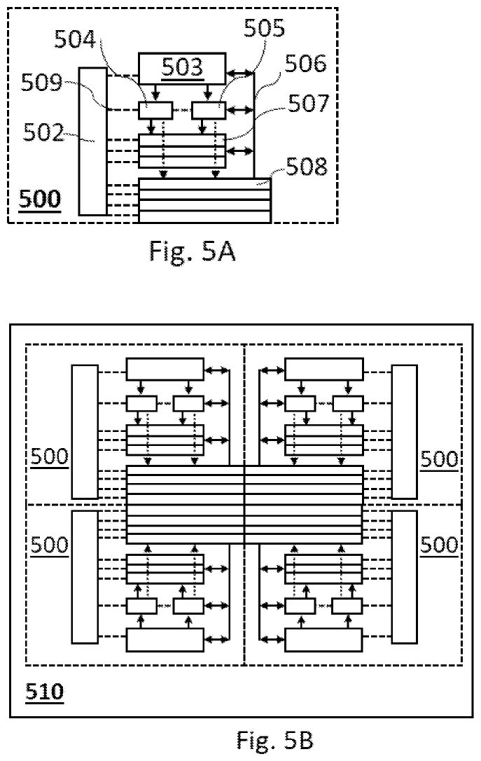

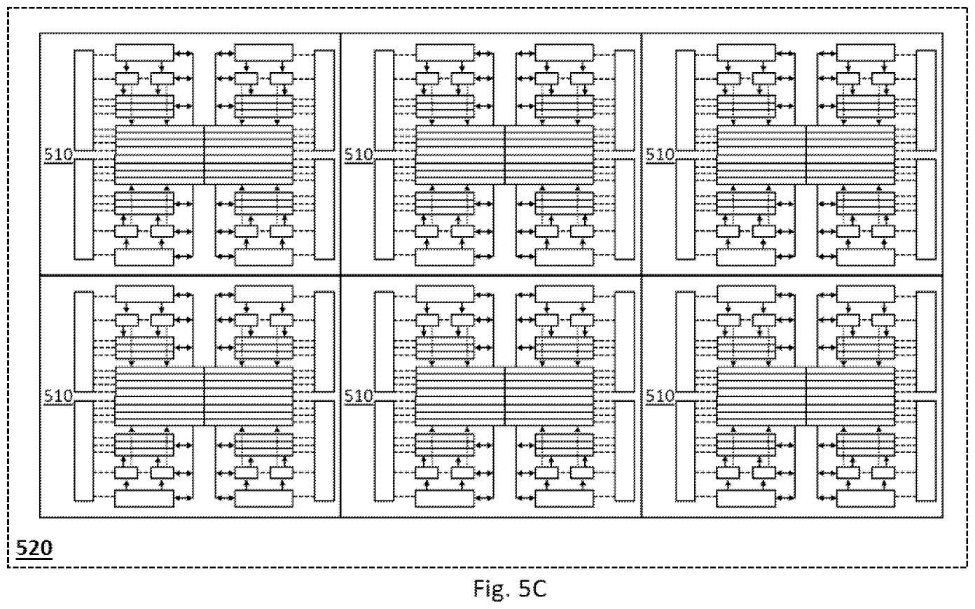

In a macroprocessor 400, an FAU 412 is constructed as a plurality of programmable slices. This construction is shown in 500 of FIG. 5A. In 500, 502 comprises a control unit coupled to all hardware blocks; 503 comprises a local shared memory unit such as L2-cache; 504 comprises an L1 I-cache that stores instructions; and 507 comprises an L1 D-cache that stores data. 507 comprises one or more of ISA-compatible HWU such as ALU, FPU, BRU, etc. such that each HWU instruction has a matching ISA defined compiler translation. 508 comprises a plurality of FAUs arranged in a layout arrangement so that the FAUs can be combined to build larger Hardware-Macros. A FN-Pragma identified software content may be positioned in one FAU, or a plurality of FAUs. Outputs of ISA-HWU 505, and FAU 508 are coupled into data bus 506, as well as L2-cache 503 to exchange data. Instructions in 509 may be executed in ISA-HWU 507, and/or FAUs 508. A plurality of instructions may be executed concurrently in a plurality of ISA-HWU 507 and a plurality of FAUs 508 concurrently. It is understood that issue-queues, tags & data flow must be managed to process parallel instructions concurrently. In another embodiment, the macroprocessor construction 500 may comprise one or more scratch-pad memory (not shown) to facilitate data movement to hardware units 507 and 508 from L1 D-cache 507. In yet another embodiment, the FAU 508 may comprise a memory management unit to access data in a scratch-pad storage memory, or any other memory.

A plurality of content compute units 500 may be combined into a content compute block 510 as shown in FIG. 5B. In this construction, the FAUs are constructed to abut in adjacent compute units such that FN-Pragma software content can be programmed into FAUs 510 that abuts to form a sea of programmable logic gates. A plurality of compute blocks 510 may be combined into a content compute tile 520 shown in FIG. 5C. A user identified software content may be compiled into a macro-function that may utilize a compute unit 500, or a compute block 510, or a compute tile 520.

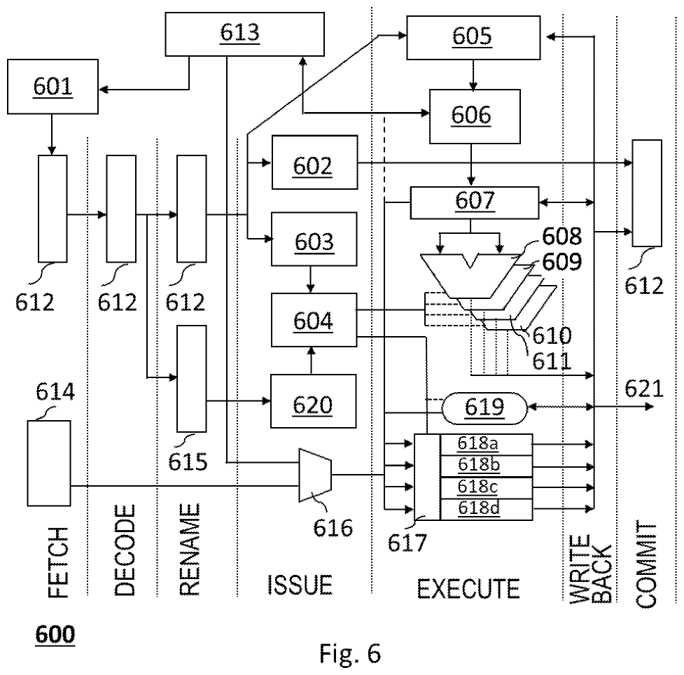

Another embodiment of a compute processor 600 is shown in FIG. 6. Compute processor 600 comprises L3-cache 614 & L2-cache 613. L3 cache to L2 cache data flow is not shown. Processor 600 includes a microprocessor, such as in FIG. 2A, with related hardware components. For illustrative purposes a 7-stage (fetch, decode, rename, issue, execute, write back & commit) pipelined microprocessor (aka CPU) is shown. A CPU includes load-store unit 605, I-cache 601, D-cache 606, data registers 607, control unit 604, ALU 608, FPU 609, AGU 610 & BRU 611, typically found in a RiscV ISA-HWA. A CPU further includes a plurality of register files 612. Compute processor 600 includes: decode logic (not shown) to generate FAU 618 instructions between from CPU instruction rename register 612 to a parallel macro-function rename register 615, and a FAU 618 specific instruction issue queue 620. A configurable multiplexer 616 allows data selection to FAU 618 from one of L2-cache 613 and L3-cache 614 to provide high band-width data access. A plurality of FAUs 618 is boot-time configurable, and/or dynamically re-configurable as discussed earlier. FAU 618 comprises static and dynamic configuration elements. Static configuration elements are programmed at boot-time, while dynamic configuration elements are programmed during run time. Each FAU 618 comprises look up table (LUT) logic and segmented routing wire configurability, typically found in FPGA HWAs. These structures are modified by interconnect structures described in application Ser. No. 18/656,854 entitled “Interconnect Structures for Configurable CPU Pipelines”. A plurality of FAUs 618 may be combined to build a larger macro-function. Each FAU 618 further comprises DSP slices, carry-logic & registers. Each FAU 618 is further capable of including any other custom hardware units. A plurality of FAUs 618 is coupled to a local data-cache 617, which comprises one or more storage elements, preferably single-port or multi-port SRAM memory. FAUs 618 may receive compute data from one of: L1 D-cache 606, ISA-HWU 608-611 input registers 607, L2-cache 613 and L3-Cache 614. Compute processor 600 comprises a control unit 604 coupled to ISA-HWU 608-611 issue queue 603 and FAU 618 issue queue 620. 602 is the re-order buffer. Executing CPU instruction in 603 activates control unit 604 signals to manage data-flow and functions in CPU section, whereas executing one or more FAU instructions in issue queue 620 activates control unit 604 signals to manage data-flow and functions in FAU 618 section. A plurality of FAUs 618 may be configured to execute multiple parallel execution (SIMD, single-instruction multiple-data) or a plurality of different instructions (MIMD, multiple-instructions multiple-data) in one cycle. This is possible since the instruction-functionality resides in configuration bits, and different instructions can be pre-programmed to reside within the FAU 618. An FAU issued instructions has to only ensure correct synchronized data flow to the inputs of each FAU. Compute processor 600 includes a configurable data-flow mixer 619 (hereafter called the mixer) that can dynamically route ISA-HWU 608 and FAU 618 output data to any other input-port providing a one cycle feed-through mechanism for data-flow between functional units. Mixer 619 may be a portion of FAU 618 hardware. This mixer 619 may be dynamically configured by control unit 604, as described in FIG. 3C, using control signals. Mixer 619 may be a ring connector that traverse input and output ports. The exact functionality of the mixer is described in the incorporated by referenced Provisional Application entitled “Macro-Processor Architectures”. Mixer 619 dynamically concatenates a plurality of FAUs 618 to build larger Macro-Functions that significantly boost performance efficiency. Mixer 619 allows pre-processing ISA-HWU functional unit 608-611 input data using FAU 618 function outputs. Mixer 619 allows post-processing ISA-HWU functional unit 608-611 output data using FAU 618 function inputs. As an example, a significant usefulness of this feature is for a first FAU 618a to decompress incoming compressed data, feed the output of 618a to a second slice 618b to decode incoming encoded data, feed the real data output of 618b to ISA-ALU 608 or ISA-FPU 609 for data-compute. This auto-pipelining is dynamically generated by software tools, described later, independent of Software Application developer intervention. FAUs 618 may receive data from L1-cache 606 and write results back to L1-cache or a scratchpad (not shown) without the need to retire data to L2-cache 613 for access, thereby improving data compute performance. FAU 618 and Mixer 619 may feed-through output data to an adjacent compute cluster via output 621, allowing FAU & Functional-Unit sharing for data compute in multiple clusters. Depending on the position of cluster-to-cluster feed-through required, a latency may be predetermined and managed by the control unit(s) 604. FAU 618 memory 617 may contain a plurality of sets of configuration bit values. A said first set of configuration-bit values may configure a FAU 618a to a first function. A said second set of configuration-bit values may configure the same FAU 618a to a second function. A control signal from control unit 604 may select the first set or the second set of data sets in memory 617 to configure the FAU 618a, thereby providing a control option to dynamically change FAU 618a functionality via control-unit 604. In one embodiment this may take 1-cycle. In another embodiment this may take a few cycles. In yet another embodiment this may take 1000's of cycles, managed by the control unit 604 pre-emptively or during wait-for-interrupt idle time. The reconfigurable latency may depend on the extend and complexity of FAU 618a functionality. Memory 617 may store 128 sets of configuration data sets that define 128 different 8LUT functions, one stored function selected by a 10-bit memory 617 select address code generated by control unit 604 to configure FAU 618 as desired. Mixer 619 may be used to dynamically adjust output-input connectivity to improve content processor 600 functionality through a software mechanism that is discussed next. Configuration elements in FAU 618 may be sub-divided into static configuration elements and dynamic configuration elements. FAU 618 comprises a configuration circuit. Static configuration elements may be programmed during a boot-time of a program using a bit-stream via the configuration circuit. Dynamic configuration elements may be programmed by a bit-code provided by the control unit 604. FAU 618 may comprise a slave control unit, further comprising storage elements. Slave control unit may generate a storage element pattern in response to a bit-code received from control unit 604, to further generate control signals to program the dynamic configuration elements. Together, the static and dynamic configuration element pattern may define a plurality of macro-functions. A unique dynamic configuration clement pattern and the static configuration element pattern may define a unique macro-function. The control unit 604 generated bit-code may dynamically alter the macro-function in FAU 618.

FAU 618 accelerator instruction execution in FIG. 6 is discussed next. FAU 618 is coupled to a second control unit 622. In a first embodiment control unit 604 acts as the master, while control unit 622 acts as a slave. In a second embodiment, the control unit 622 acts as the master, while control unit 604 acts as a slave. The coupling between the two control units may be via a plurality of control and status registers (CSR). The execution of instructions in FAU 618 may be completely delegated to control unit 622 by control unit 604 via CSR values. Control unit 622 may have a load/store unit to manage data transfer from memory 607 to FAU 618 execution units. To ensure cache coherency, there may be an intermediate data buffer (a scratch pad, or an L0 cache) for data that is needed for CPU hardware 608-611 and FAU hardware 618. A first load/store unit under control unit 604 control manage data transfers between CPU L0 cache and CPU execution units, while the load/store unit under control unit 622 control manage the data flow between the FAU L0 cache and FAU hardware 618. CSRs include stack pointers, address specifications, tags and status bits. CSRs include a designation of master-slave control between the two control units 604 & 622, a novel feature in this innovation. While 617, 618, & 622 are shown as separate geometries, this is a logical representation of the FAU. In a physical representation, collectively, this unit comprises programmable logic fabric, and the resources may be inter-dispersed. During a physical implementation phase of an identified software content conversion, a software tool syn-compiler identifies a connectivity sequence between a plurality of functions that are programmed into HWA slices 618a, 618b, . . . , 618d. The output of one slice serves as input to another slice, the connected slice sequence fully defining a concatenated slice function as a macro-function. As an example, a first macro-function may comprise a pipelined sequence 618a-618c-818b, and a second macro-function may comprise a sequence 618d-618a-618c-618b. This input port-output port connectivity is determined by the syn-compiler, providing a bit-code instruction for the control-unit 604. Control unit 604 directs a slave control unit in the Mixer 619 to generate the dynamic connectivity as described in 320 of FIG. 3B. Mixer 619 comprise storage elements that are set by the bit-code received, and it allows macro function executions that can be changes cyclically, or as told by the control unit 604. Mixer 619 manages output drivers of one port (out of a plurality of output ports) coupling to an input port (out of a plurality of input ports) without contention between drivers during one-cycle or two-cycle re-configuration, as described in FIG. 3B. It may comprise a bit-programmable wire coupling, or a byte-programmable bus coupling architecture between wires and ports. Control unit 622 may execute FAU 618 instructions concurrently with control unit 604 execution of CPU 608-611 instructions. Concurrent heterogeneous computing is facilitated by independent hardware resources between CPU and FAU data paths.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as described in this disclosure document.

What is claimed is:

1. A control unit in a heterogeneous compute processor, comprising:
a master control circuit to generate a plurality of master control signals to select a plurality of pre-defined hardware structures to execute a compiled micro instruction; and
a slave control circuit to receive a bit-code directive from the master control circuit and generate a plurality of slave control signals to configure a plurality of pre-programmed hardware structures to a compiled function to execute the compiled function instruction.

2. The device of claim 1, wherein the slave control unit further comprising:
a plurality of storage elements, each storage element generating a said slave control signal, and a configurable means to program the plurality of storage elements based on the bit-code directive, the method comprised of:
resetting the storage elements to a first state during a first clock period; and
programming the storage elements to a decoded bit-code generated pattern during a second clock period.

3. The device of claim 1, wherein the master control circuit further comprising:
a sequencer circuit to identify the compiled micro instruction execution cyclical steps; and
a level and a pulse control signal generation circuit for each of the identified cyclical steps, and using the level and the pulse signals to select the hardware structures needed during the cycle step; and
a logic circuit to aggregate all of the level signals that select a hardware structure across all the cyclical steps of micro instructions in an instruction set architecture for each of said hardware structures available for selection; and
a logic circuit to aggregate all of the pulse signals that select a hardware structure across all the cyclical steps of micro instructions in the instruction set architecture for each of said hardware structures available for selection.

4. The device of claim 1, wherein the master control circuit further comprises a tag value in a control and status register (CSR) shared by the master control unit and the slave control unit, wherein the tag value written by the slave control unit informs the master control unit that the function instruction execution is completed.

5. The device of claim 1, wherein the master control unit comprises:
an instruction data buffer for micro instruction data, and
a function data buffer for function instruction data, and
a plurality of non-overlapping hardware structures for instruction data path and function data path, wherein the control unit facilitates concurrent instruction and function execution by utilizing the non-overlapping hardware structures between the two data paths and the two data buffers.

6. The device of claim 1, wherein a first bit-code executes a first compiled function instruction, and a second bit-code executes a second compiled function instruction.

7. The device of claim 1, wherein one of a plurality of compiled function instructions can be dynamically altered by master control unit by issuing a bit-code to the slave instruction unit.

8. The device of claim 1, wherein the slave control unit comprises a variable cycle count sequencer circuit, wherein the cycle count is programmed by setting a plurality of storage memory element values in the variable cycle count sequencer circuit.

9. The device of claim 6, wherein the variable cycle sequencer is constructed in a programmable logic content coupled to the slave control unit.

10. A control unit to execute a micro instruction and an accelerator instruction in a processor, comprising:
a means to navigate a micro instruction to a selectable plurality of pre-defined hardware units and select a pre-defined hardware unit to execute the micro instruction; and
a means to navigate an accelerator instruction to a programmable logic hardware block programmed as an accelerator function and execute the accelerator instruction;
wherein, the micro instruction data and accelerator instruction data reside in a common coherent cache memory structure.

11. The device of claim 10, wherein the micro instruction data utilizes a micro data buffer in a micro data path, and the accelerator instruction data utilizes an accelerator data buffer in an accelerator data path, and wherein the data movement paths between micro data and accelerator data do not share common hardware structures to execute both instructions concurrently.

12. The device of claim 11, wherein the micro data buffer and the micro data path comprises a first data width defined by an instruction set architecture (ISA), and the accelerator data buffer and the accelerator data path comprise a second data width significantly wider than said first data width, the second data width to first data width ratio exceeding a factor of 4, and preferable exceeding a factor of 16, and more preferably exceeding a factor of 32.

13. The device of claim 10, wherein the control unit comprises a fetch unit, and wherein micro instructions fetched by the fetch unit are queued in a micro fetch buffer, and wherein accelerator instructions fetched by the fetch unit are queued in an accelerator fetch buffer

14. The device of claim 12, wherein the control unit comprises a first load-store unit to read and write data between the micro data buffer and a selected pre-defined hardware structure, and engage a slave controller comprising a second load-store unit to read and write data between the accelerator data buffer and the programmed hardware function accelerator block.

15. The device of claim 14, wherein the second load-store unit control is managed by the programmed accelerator hardware block, and wherein the control unit and second load-store unit exchange communication via a plurality of fixed control and status register settings.

16. The device of claim 10, wherein:
the means to navigate micro instruction further comprising:
decoding the micro instruction; and
assigning decoded micro instruction to a micro instruction buffer, and
generating cycle-by-cycle control signals to select one or more pre-defined hardware structures for each cyclical segment of the micro instruction; and
the means to navigate accelerator instruction further comprising:
decoding the accelerator instruction; and
assigning decoded accelerator instruction to an accelerator instruction buffer, and
passing one or more parameters via a plurality of control and status register settings for a slave control unit to navigate the accelerator instruction in the programmable logic hardware block.

17. A control unit to facilitate a function instruction execution of a processor, comprising:
a slave control unit to receive a command from the control unit via a plurality of control and status registers to execute a function programmed in a programmable logic block.

18. The device of claim 17, wherein the slave control unit comprises a plurality of control signals to configure the function from a plurality of pre-programmed subfunctions.

19. The device of claim 18, wherein a said subfunction further comprises a plurality of configurable memory elements, and a plurality of programmable logic elements, and a said pre-programmed subfunction comprises a bit-pattern of the plurality of configurable memory elements to program the plurality of programmable logic elements.

20. The device of claim 17, wherein the control unit further comprises a means to generate cycle by cycle hardware control signals to select a pre-defined hardware structure to execute a compiled micro instruction from a set of an instruction set architecture (ISA).
